(19) United States
(12) Patent Application Publication
(10) Pub. No.: US 2019/0164367 A1
(43) Pub. Date: May 30, 2019

(54) METHODS AND DEVICES FOR MANAGING ACCESS TO A VEHICLE

(71) Applicant: Keyfree Technologies Inc., Toronto (CA)

(72) Inventor: Matthew VINCENTI, Toronto (CA)

(21) Appl. No.: 16/262,716

(22) Filed: Jan. 30, 2019

Related U.S. Application Data
(63) Continuation of application No. 16/008,476, filed on Jun. 14, 2018.
Application No. 16/008,476 is a continuation of application No. 14/778,953, filed on Sep. 21, 2015, now abandoned.
Application No. 14/778,953 is a continuation-in-part of application No. PCT/CA2013/000600, filed on Jun. 25, 2013.
(60) Provisional application No. 61/804,338, filed on Mar. 22, 2013.

(51) Int. Cl. G07C 9/00; H04W 12/08; H04W 12/04; H04L 29/08; H04W 4/80

(52) U.S. Cl. CPC G07C 9/00857; H04W 12/08; H04W 12/04; G07C 9/00309; G07C 9/00571; H04L 63/062; H04W 4/80; G07C 2209/63; G07C 2009/00793; G07C 2009/00865; H04L 67/125

(57) ABSTRACT

Methods, system, mobile node, administrative module for managing access to a vehicle and/or for activating temporary access to the vehicle. A fixed unit comprising a short range transceiver is provided in the vehicle, for managing access thereto the vehicle. A virtual key is provided to the mobile device that has a primary function other than virtual key management. The fixed unit interacts only via the short range transceiver while granting access, the virtual key may be associated by the mobile device to a valet key device for granting conditional access to the vehicle.

### PRIORITY STATEMENT

This non-provisional patent application is a continuation of U.S. patent application Ser. No. 16/008,476, filed Jun. 14, 2018, which is a continuation of U.S. patent application Ser. No. 14/778,953, filed Sep. 21, 2015, which is a 371 of International Patent Application PCT/CA2014/000282, filed Mar. 21, 2014, which is a continuation in part of International Patent Application PCT/CA2013/000600, filed Jun. 25, 2013, which claims priority based upon the prior U.S. provisional patent application application No. 61/804,338, filed Mar. 22, 2013, and the PCT application number PCT/CA2014/000282, filed Mar. 21, 2014.

### TECHNICAL FIELD

The present invention relates to key administration and, more particularly, to wireless key access administration.

### BACKGROUND OF THE INVENTION

In recent years, the usage of conventional keys in the automotive industry has diminished, and new methods enabling access to vehicles are developing. Typical car keys are easily lost, misplaced, forgotten and can be both costly for the driver and inconvenient in terms of the time lost in which they can be remade. Furthermore, the idea of manipulating keys is gradually fading due to the increasing habits of individual consumers that want to carry the least articles possible.

The present invention aims at addressing at least some of these shortcomings.

### SUMMARY OF THE INVENTION

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present invention is directed to a method for managing access to a vehicle. The method comprises providing a fixed unit, in the vehicle, for managing access to the vehicle, the fixed unit comprising a short range radio transceiver and activating a virtual key, for granting access to the vehicle, based on a unique identifier of the fixed unit. The virtual key is then provided, over a network, for local storage into a mobile device. The mobile device has a primary function other than virtual key management. The method also comprises programming the fixed unit for granting access to the vehicle upon identifying the mobile device. The fixed unit interacts only via the short range radio transceiver while granting access.

Optionally, providing the virtual key may further comprise sending the virtual key to the mobile device for reception via a long range radio transceiver of a network interface module of the mobile device.

The virtual key may also have a preset expiry condition and the method may then further comprise disabling the virtual key in the mobile device, without confirming via the long range radio transceiver, when the condition is met. The disabled key prevents the mobile device from requesting access to the fixed unit over the short range radio transceiver.

The virtual key may also grant access to a set of functions of the vehicle and the method may then further comprise programming the fixed unit for granting access to the set of functions of the vehicle upon identifying the mobile device. The method may also optionally further comprise activating a second virtual key, for granting access to the vehicle and to a subset of the set of functions of the vehicle, based on the unique identifier and programming the fixed unit for granting access to the vehicle and to a subset of the set of functions of the vehicle upon receiving credentials related to the second virtual key from a second mobile device. In this example, the fixed unit interacts only via a short range radio transceiver while granting access and the second mobile device has a primary function other than virtual key management.

The method may also comprise, at the fixed unit, measuring a speed at which the mobile device is approaching the vehicle to determine when to grant access to the vehicle.

As another option, the method may further comprise sending, to the mobile device, a content file for transmission to the fixed unit over the short range radio transceiver when the mobile device is connected therewith. An audio and/or video content from the content file may further be conditionally provided by the fixed unit within the vehicle. The content may be provided based on one or more of vehicle engine being on or off, vehicle engine RPMs, vehicle doors being locked or not, vehicle radio being on or off, noise level within the vehicle.

In some embodiments (e.g., fleet management) a plurality of virtual keys may be provided and a plurality of fixed units may be deployed over a plurality of vehicles.

The fixed unit may be provided for installation in the vehicle.

Optionally, parameters of the virtual key may indicate at least one condition of the virtual key to the fixed unit and the method may then further comprise providing a warning within the vehicle, from the fixed unit, in relation to the condition. After providing the warning, the method may further comprise safely disabling the virtual key, from the fixed unit, when the condition is met.

A second aspect of the present invention is directed to a method for activating temporary access to a vehicle comprising a fixed unit for managing access to the vehicle, the method comprising, from a mobile device, associating a virtual key to a valet key device for granting conditional access to the vehicle, the mobile device having a primary function other than virtual key management and from the mobile device, communicating the parameters of the virtual key to the fixed unit using a short range radio transceiver.

The method may further comprise, from the fixed unit, granting access to the vehicle upon detecting a request from the valet key device matching the received parameters.

The valet key device may be a conventional remote key of the vehicle or the valet key device may be equipped with a short range radio transceiver. In this second exemplary case, the method may further comprise, from the mobile device, communicating the parameters of the virtual key to the valet key device using the short range radio transceiver.

The parameters of the virtual key may further indicate at least one function of the vehicle accessible to the valet key device. The parameters of the virtual key may also further indicate at least one time or distance condition and the method may then further comprise providing a warning within the vehicle, from the fixed unit, based on the time or distance condition.

A third aspect of the present invention is directed to a method for managing access to a vehicle comprising creating a virtual key, for granting access to the vehicle, based on a unique identifier of a fixed unit to be installed in the vehicle and programming the fixed unit for granting access to the vehicle upon receiving credentials related to the virtual key from a mobile device. The fixed unit interacts only via a short range radio transceiver while granting access and the mobile device has a primary function other than virtual key management. The method also comprises generating an activation code based on the unique identifier of the fixed unit and remotely activating the virtual key within the mobile device upon receiving the activation code from the mobile device over a network.

The virtual key may optionally grant access to a set of functions of the vehicle and the method may further comprise programming the fixed unit for granting access to the set of functions of the vehicle upon receiving credentials related to the virtual key from the mobile device. The virtual key may also grant access to a set of functions of the vehicle and the method may then further comprise creating a second virtual key, for granting access to the vehicle and to a subset of the set of functions of the vehicle, based on the unique identifier and programming the fixed unit for granting access to the vehicle and to a subset of the set of functions of the vehicle upon receiving credentials related to the second virtual key from a second mobile device. In this example, the fixed unit interacts only via a short range radio transceiver while granting access and the second mobile device has a primary function other than virtual key management. The method may also comprise generating a second activation code based on the unique identifier of the fixed unit and remotely activating the second virtual key within the mobile device upon receiving the activation code from the second mobile device over the network.

A fourth aspect of the present invention is directed to a system for managing access to a remote vehicle comprising a fixed unit, in the vehicle, for managing access to the vehicle, the fixed unit comprising a short range radio transceiver and an administrative agent for activating a virtual key based on a unique identifier of the fixed unit, the virtual key granting access to the vehicle, providing the virtual key, over a network, for local storage into a mobile device, the mobile device having a primary function other than virtual key management and programming the fixed unit for granting access to the vehicle upon identifying the mobile device, wherein the fixed unit interacts only via the short range radio transceiver while granting access.

The administrative agent may further send the virtual key to the mobile device for reception via a long range radio transceiver of a network interface module of the mobile device.

The virtual key may have a preset expiry condition and the mobile device may disable the virtual key without confirming via the long range radio transceiver, when the condition is met, the disabled key preventing the mobile device from requesting access to the fixed unit over the short range radio transceiver.

The virtual key may grant access to a set of functions of the vehicle and the administrative agent may further program the fixed unit for granting access to the set of functions of the vehicle upon identifying the mobile device. The administrative agent may further activate a second virtual key, for granting access to the vehicle and to a subset of the set of functions of the vehicle, based on the unique identifier and program the fixed unit for granting access to the vehicle and to a subset of the set of functions of the vehicle upon receiving credentials related to the second virtual key from a second mobile device. In this example, the fixed unit interacts only via a short range radio transceiver while granting access and wherein the second mobile device has a primary function other than virtual key management.

The system may further comprise, at the fixed unit, measuring a speed at which the mobile device is approaching the vehicle to determine when to grant access to the vehicle.

The administrative agent may further send, to the mobile device, a content file for transmission to the fixed unit over the short range radio transceiver when the mobile device is connected therewith, wherein an audio and/or video content from the content file is conditionally provided by the fixed unit within the vehicle. The content may be provided based on one or more of vehicle engine being on or off, vehicle engine RPMs, vehicle doors being locked or not, vehicle radio being on or off, noise level within the vehicle.

The system may comprise a plurality of virtual keys and a plurality of fixed units deployed over a plurality of vehicles.

Parameters of the virtual key may indicate at least one condition of the virtual key to the fixed unit and the fixed unit may further provide a warning within the vehicle, from the fixed unit, in relation to the condition. The fixed unit may, after providing the warning, safely disable the virtual key when the condition is met.

A fifth aspect of the present invention is directed to a mobile device for activating temporary access to a vehicle comprising a fixed unit for managing access to the vehicle. The mobile node comprises a security module for associating a virtual key to a valet key device for granting conditional access to the vehicle, the mobile device having a primary function other than virtual key management and communicating the parameters of the virtual key to the fixed unit using a short range radio transceiver.

The parameters of the virtual key may require the fixed unit to grant access to the vehicle upon detecting a request from the valet key device matching the received parameters.

The security module may further communicate the parameters of the virtual key to the valet key device valet key device, equipped with a short range radio transceiver, using the short range radio transceiver. The parameters of the virtual key may indicate at least one function of the vehicle accessible to the valet key device. The parameters of the virtual key may also indicate at least one time or distance condition for providing a warning within the vehicle based on the time or distance condition.

A sixth aspect of the present invention is directed to an administrative agent for managing access to a vehicle comprising a network interface module and a security module for creating a virtual key, for granting access to the vehicle, based on a unique identifier of a fixed unit to be installed in the vehicle, programming the fixed unit for granting access to the vehicle upon receiving credentials related to the virtual key from a mobile device, generating an activation code based on the unique identifier of the fixed unit and remotely activating the virtual key, via the network interface module, within the mobile device upon receiving the activation code from the mobile device over a network. The fixed unit interacts only via a short range radio transceiver while granting access and the mobile device has a primary function other than virtual key management.

The virtual key may grant access to a set of functions of the vehicle and the security module may further program the fixed unit for granting access to the set of functions of the vehicle upon receiving credentials related to the virtual key from the mobile device. The virtual key may grant access to a set of functions of the vehicle and the security module may further create a second virtual key, for granting access to the vehicle and to a subset of the set of functions of the vehicle, based on the unique identifier, programming the fixed unit for granting access to the vehicle and to a subset of the set of functions of the vehicle upon receiving credentials related to the second virtual key from a second mobile device, generating a second activation code based on the unique identifier of the fixed unit and remotely activating via the network interface module, the second virtual key within the mobile device upon receiving the activation code from the second mobile device over the network. The fixed unit interacts only via a short range radio transceiver while granting access and the second mobile device has a primary function other than virtual key management.

A first additional aspect in accordance with other embodiments of the present invention is directed to a method for granting access to a restricted area comprising (a) pairing a unit located in the restricted area with a mobile device, wherein the unit manages access to the restricted area, (b) monitoring, from the unit, a perimeter surrounding the restricted area using a short range radio transceiver of the unit, (c) determining, at the unit, that the mobile device is within the perimeter and (d) upon determination that the mobile device is within the perimeter, granting access to the restricted area.

Optionally, pairing the unit with the mobile device may further comprise storing a unique identifier of the mobile device in the unit and determining that the mobile device is within the perimeter may further comprise (i) receiving, at the unit, the unique identifier of the mobile device in a message sent from the mobile device through a short range radio transceiver of the mobile device and (ii) matching the unique identifier, at the unit, with the stored unique identifier. Pairing the unit with the mobile device may yet further comprise storing in the unit, in addition to the unique identifier of the mobile device, a primary key associated to a user account of the unit, wherein the primary key is further stored on the mobile device. As a complementary option, the method may also comprise logging into the user account via a long range radio transceiver of the mobile device and downloading the primary key for storage on the mobile device. The method may also comprise logging into the user account, requesting generation of a further key for a further mobile device and allowing storage of the further key on the further mobile device. The further key may provide at least a subset of rights granted to the primary key. The further key at the unit may further be stored in the unit. The further key may be provided to the unit via one of a long range radio transceiver of the unit, the short range radio transceiver of the unit or a wired data interface of the unit. The long range radio transceiver may be a wireless local access area network interface or a cellular network interface.

As another option, the method may comprise installing the unit in a vehicle and allowing the unit to instruct the vehicle door lock mechanism. Granting access to the restricted area may thus further comprise activating the door lock mechanism to unlock the doors. The method may also comprise allowing the unit in the vehicle to instruct the vehicle ignition system. The method may thus further comprise receiving, at the unit, a predetermined signal and, upon determination that the mobile device is within the perimeter and upon reception of the predetermined signal, instructing the vehicle ignition system to start the engine. Allowing the unit in the vehicle to instruct the vehicle ignition system may be performed through an onboard computer of the vehicle, through a dedicated ignition control system or through direct instructions from the unit to the ignition system and the predetermined signal may be received from the onboard computer of the vehicle, the dedicated ignition control system or from an interface of the unit installed in the vehicle.

The method may further comprise logging events in the unit into an event log stored in the unit and sending the event log upon reception of a request.

The short range radio transceiver may be a Bluetooth™ network interface.

A second additional aspect in accordance with other embodiments of the present invention is directed to an apparatus for granting access to a restricted area in which the apparatus is located. The apparatus comprises (a) a short range radio transceiver, (b) a pairing module, (c) a monitoring module and (d) an access module.

The pairing module is for pairing the apparatus with a mobile device, wherein the apparatus manages access to the restricted area. The monitoring module is for (i) monitoring a perimeter surrounding the restricted area using of the short range radio transceiver and (ii) determining that the mobile device is within the perimeter. The access module is for granting access to the restricted area upon determination that the mobile device is within the perimeter.

Optionally, the apparatus may further comprise a memory module for storing a unique identifier of the mobile device. The determining module may thus further (i) receive the unique identifier of the mobile device in a message sent from the mobile device through a short range radio transceiver of the mobile device and (ii) match the unique identifier with the stored unique identifier. The memory module may further store, in addition to the unique identifier of the mobile device, a primary key associated to a user account of the apparatus, the primary key being optionally further stored on the mobile device. The memory module may also store a further key for a further mobile device. The further key may provide at least a subset of rights granted to the primary key and be provided to the apparatus via one of a long range radio transceiver, the short range radio transceiver or a wired data interface.

As another option, the apparatus may be installed in a vehicle and the access module may be allowed to instruct the vehicle door lock mechanism. Granting access to the restricted area may thus further comprise activating the door lock mechanism to unlock the doors. The apparatus may further comprise an advanced function module allowed to instruct the vehicle ignition system. The advanced function module may receive a predetermined signal and, upon determination that the mobile device is within the perimeter and upon reception of the predetermined signal, instruct the vehicle ignition system to start the engine. The advanced function module may further instruct an onboard computer of the vehicle, a dedicated ignition control system or directly instruct the ignition system. The predetermined signal may be received from the onboard computer of the vehicle, the dedicated ignition control system or from an interface of the apparatus installed in the vehicle.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

Further features and exemplary advantages of the present invention will become apparent from the following detailed description, taken in conjunction with the appended drawings, in which:

FIG. 1 is a logical representation of an exemplary process between a mobile device, a unit within a vehicle, and a cloud administration, holding all the authentication and memory data.

FIG. 2 is a logical representation of exemplary types of users for administering and managing keys on a cloud administrator.

FIG. 3 is an exemplary representation of different limitations that a primary key can impose on secondary and shared keys.

FIG. 4 is a logical representation of an exemplary first-time syncing process for a primary user.

FIG. 5 is a logical representation of an exemplary first-time syncing process for secondary users.

FIG. 6 is a logical representation of an exemplary long-range communication between a primary key and a shared user.

FIG. 7 is a logical representation of an exemplary graphical user interface of executable program on a mobile device capable of interacting automatically and physically, enabling certain functions of a vehicle.

FIG. 8 is a logical representation of an exemplary locking/unlocking and ignition procedure when a key user is in proximity to a vehicle.

FIG. 9 is a logical representation of an exemplary communication process between a mobile device and a unit when a vehicle is being mobilized.

FIG. 10 is a logical representation of an exemplary alternate access mode controlled by a primary key holder allowing limited time access and functional constraints on a vehicle through a use of an alternate key. In the embodiment depicted, the alternate key is a key fob.

FIG. 11 is a logical representation of an exemplary log being reported on an interface of a primary user's mobile device.

FIG. 12 is a logical modular representation of an exemplary system in accordance with the teachings of the present invention.

FIG. 13 is a flow chart of a first exemplary method in accordance with the teachings of the present invention.

FIG. 14 is a flow chart of a second exemplary method in accordance with the teachings of the present invention.

FIG. 15 is a flow chart of a third exemplary method in accordance with the teachings of the present invention.

FIG. 16 is a flow and nodal operation chart of an exemplary embodiment in accordance with the teachings of the present invention.

### DETAILED DESCRIPTION OF THE INVENTION

Although electronic industries have responded to current trends by developing remote control keys that operate through mobile devices, an underlying issue remains. Drivers still wish to physically interact with a remote control to operate the onboard functions of a vehicle, for example, the lock or unlock function, ignition mechanism, audio or lighting features. The radio frequency communication is done interactively through live Internet connection, requiring mass amounts of data transmission from the device installed in the vehicle. This translates into devices requesting a live feed to impose data plan fees on the user of the vehicle.

The present invention comprises at least two components. A first component (e.g. fixed unit) may be located in an area for which access may be restricted (e.g., a car that can be locked), and equipped with a radio transceiver. A second component may take the form of a mobile device, comprising logic configured to interact with the first component through a radio transceiver of the second component. The first component and the second component communicate with each other in order to control remote keyless operations to the restricted area, replacing at least partially the usage of a conventional key. For instance, the present invention may be used for controlling the functions of a vehicle through a passive remote keyless entry system without the need for constant internet connectivity. The mobile device may act as a keyless entry system granting access to an otherwise restricted area to a user. The mobile device may also serve, in the automotive context, as a keyless ignition system allowing the user to start a vehicle without the need to touch or otherwise interact with the mobile device.

One embodiment of the present invention provides a method of communication between a unit, situated in the vehicle (comprising a transceiver), and a passive keyless integrated device that operates via short-range cellular communication. The unit monitors and authenticates the passive keyless integrated device based on short-range connectivity. The unit installed in the automobile uses, for example, short-range radio frequencies to communicate with the passive keyless integrated device, which then acts as a key for the vehicle. In accordance with this embodiment of the present invention, an advanced process of communication between automobiles and the passive keyless integrated devices is provided for enabling the access to certain areas of the onboard computer functions of a vehicle based on short-range communication signals. Upon authentication of the passive keyless integrated device by the unit, the unit may activate or disengage mechanical functions of the vehicle.

In one embodiment, the unit may actively scan and detect when an approved mobile device is near the vehicle. The lock/unlock functions of the vehicle may become operable only when the system detects the approved mobile device within a specified range. The invention may authorize or deny the access to users without requiring the users to interact with the approved mobile device. The user is granted access to the vehicle (e.g., the vehicle unlocks one or more doors) without specifically needing to physically contact the approved mobile device, a conventional key or the vehicle. In another embodiment, the mobile device also enables the ignition mechanism to start. Without the presence of the mobile device, the driver cannot mobilize the vehicle.

In a preferred embodiment, as soon as the user enters the vehicle, both the detection of the mobile device by the unit and initiation of the ignition mechanism are required to activate the ignition process of the vehicle.

In certain embodiments, the mobile device may store an identification code associated to the user. The identification code is shared with the unit and saved in cache memory thereof and may further be shared between more than one mobile device, allowing all the devices to be used as keys.

If a loss of Internet connection occurs, a cache memory will be used to store the last saved primary key and secondary key, allowing the key holder to enter the car. Cache memory is to allow offline usage of the keys.

Although features of the vehicle may be displayed on the interface of the mobile device, allowing users to perform functions similar to those performed using previous remote keyless controllers; in certain embodiments, the invention will result in a sense of convenience, where the user no longer interacts with a key, or requires a key. Instead, in certain embodiments, the interaction is done by the access system rather than the user.

In certain embodiments, the authentication process may be performed via short-range signals from the mobile device. The mobile devices used may be mobile telephones capable of installing a software application, allowing the user of the mobile telephone to communicate with a fixed remote keyless system through radio frequencies.

For instance, the present invention may provide: i) an automatic lock/unlock function that connects to all doors by default when approaching the vehicle without involving any remote control action or physical manipulation; ii) an ignition mechanism process that may involve the use of a knob-switch key cap, a push to start, a brake setup, or a remote starter; iii) a virtual key sharing with other users where the primary car user can send an access key of the primary car to others, e.g., using email, text message or other methods of communication, giving them temporary or restricted access to the vehicle; iv) an activity log concerning the primary car, notifying the user when others have accessed the primary car; v) A cache memory system that recognizes an existent user without the need for internet connection and grants the user access to the vehicle; vi) Management of additional cars through single account, defined as a multi-car functionality enabling the use of one key for a number of vehicles; or vii) Utilizing the mobile device's internet access to connect to cloud administration.

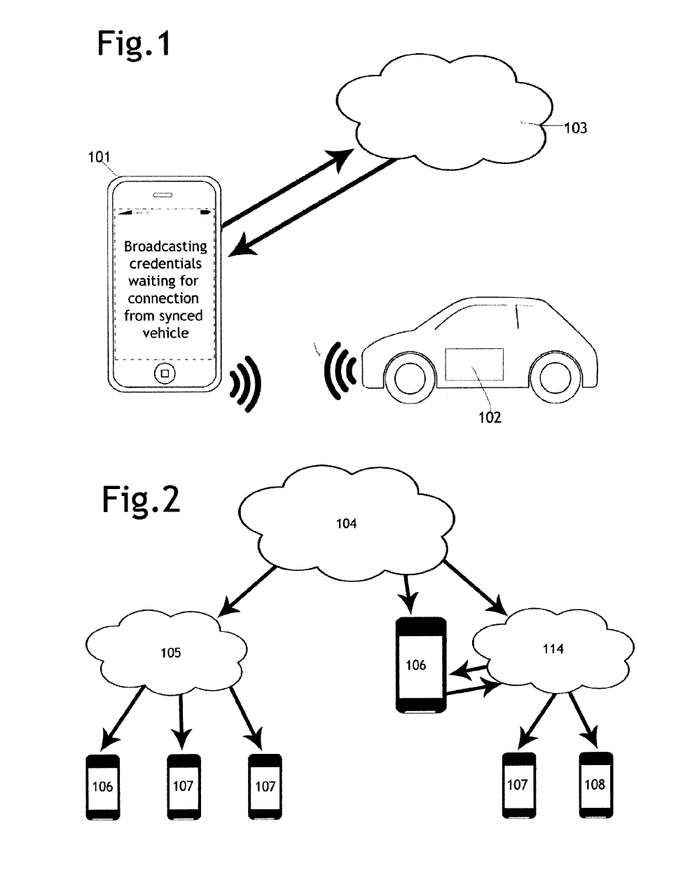

With reference to the drawings, FIG. 1 depicts an exemplary network comprising a mobile device 101, broadcasting short-range wireless signal and transmitting its identification to a vehicle unit 102. The mobile device 101 also uses an internet access to gain authentication from a cloud administrator 103. The mobile device 101 transmits an identification number along with an executable app identification, which allows the unit 102 to recognize the unique presence of the mobile device 101. As the vehicle unit 102 searches for a specific signal, the mobile device broadcasts signals to the vehicle unit 102. In certain preferred embodiments, only when the communication is performed at a designated range, and the mobile device 101 and the unit 102 authenticate each other, is access to the vehicle granted. In the example of FIG. 1, signal recognition begins at 50 meters for wireless connection, and the authentication of the mobile device 101 is granted when the mobile device 101 is at a closer proximity to the vehicle unit 102. As the unit 102 scans for broadcasting devices like the mobile device 101, the unit 102 identifies the broadcasting devices by their identification code. The unit 101 requests executable application credentials and verifies if it is a valid identification for connection. In the case where the mobile device 101 does not have a valid Id, the unit 102 requests an authentication code and verifies whether it complies with the unit 102. The cloud administrator 103 communicates with the mobile device 101 over long-range communication (e.g., via the internet), providing access to the unit 102 through a confirmed authentication code. The mobile device 101 utilizes its own internet connectivity to communicate with the cloud administrator 103.

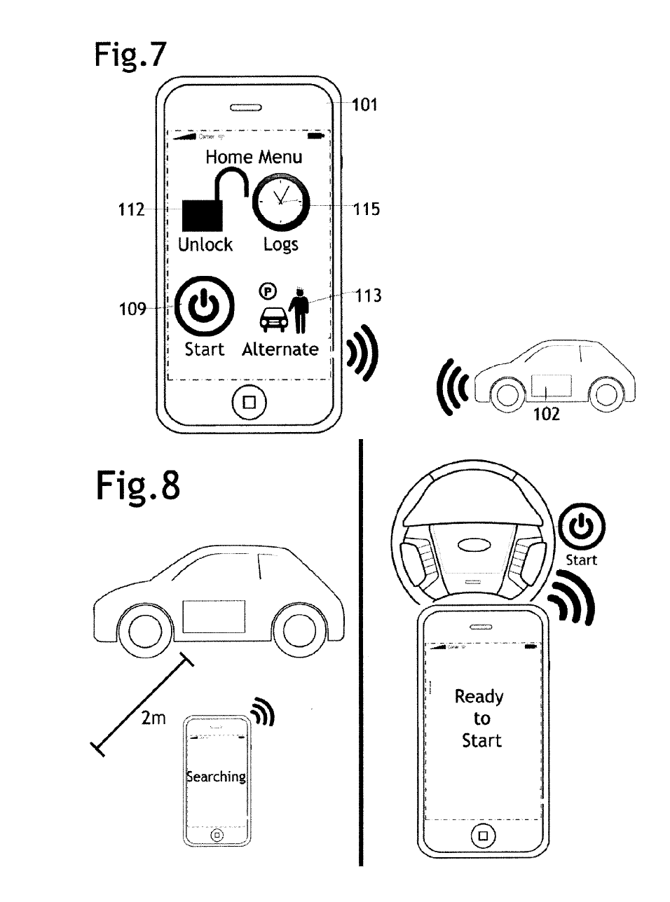

FIG. 2 illustrates an exemplary hierarchy of control and command of the distinct types of keys possessing different accessibility rights to the exemplary vehicle. At the top, a super user 104 plays the role of an online user interface, controlling all the settings of the sub users. Limited super user 105 is defined as a control center with limited accessibility to certain primary users. The limited super user 105 is an alternate feature that can be enabled or disabled depending on the purpose of the key distribution. The primary key 106 is typically defined as the key of the consumer who purchased the unit 102. The primary key 106 is designated as the original mobile device 101 paired with the unit 102, allowing certain privileges that other users do not possess. The primary key 106 can revoke keys from secondary key users, as well as revoke shared access keys. Strictly through the primary key 106, users have access to an online administrative tool 114, allowing the primary key 106 holder to delete their personal account, other secondary accounts under their account or reset keys. The secondary key 107 is identified a virtual key that can be allocated to many users by the primary key 106. Although secondary mobile devices will be designed with limitations, they still hold the ability to control some of the vehicle's function if such attributes are granted by the primary key 106 holder. Shared access key 108 is characterized as a temporary means to access the vehicle, that can be awarded to any individual through the consent and command of both primary key 106 and secondary key 107 user. Secondary key 107 users will be able to grant shared access if the primary key 106 user enables them to do so. With reference to FIGS. 7 and 10, the alternate access mode (113) is depicted. An alternate key 119 is usable to enable the lock/unlock/engine start functions of a vehicle under the permission of the primary key 106 and secondary key 107 users. Secondary key 107 users will be able to grant the alternate access mode 113 to other users as long as the primary key 106 user of the mobile device 101 enables them to do so. In the embodiment depicted, the alternate key is a key fob.

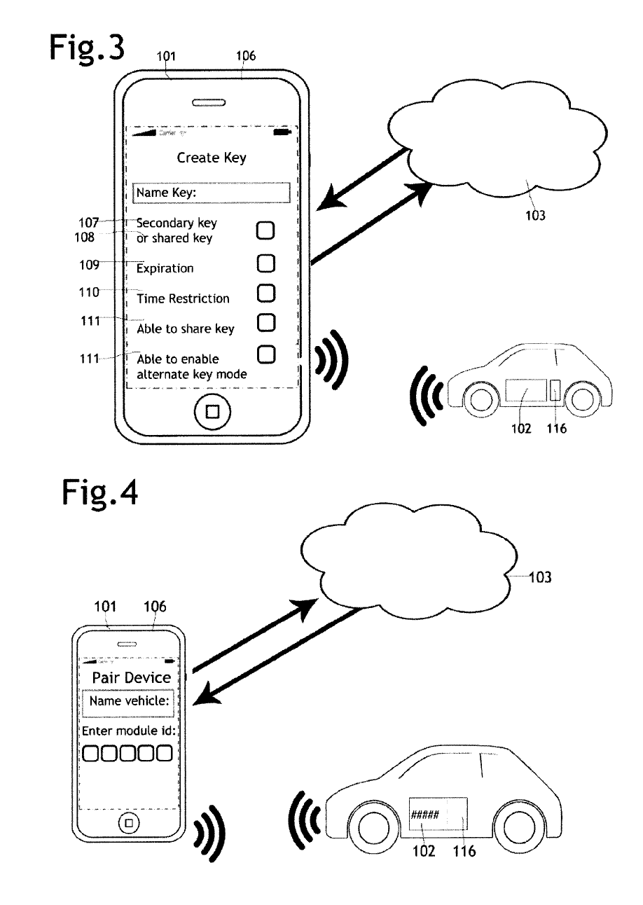

FIG. 3 demonstrates the types of access constraints, in certain embodiments of the present invention, that are enabled by the primary key 106 holder, and that can be revoked immediately. When a driver other than the primary key 106 user is employing the vehicle, the driver can be defined either as a secondary key 107 user, a shared access key 108 user, or an alternate mode 113 user. These three types of users hold temporary accessibility features to the vehicle due to their limited privileges associated with the key, however their constraints may be disabled when authority is granted by the primary key 106 user. In one embodiment, secondary, shared, and alternate users have an expiration date 109, and are limited on time usage 110. In another embodiment, the one time accessibility feature is one that applies to both the shared access key 108 and the alternate mode 113 key. Other features include the access to a select number of vehicles (e.g., restricting corporate employees to only certain vehicles). Only the secondary key (107) users may re-share their key, and only when the primary key 106 users enable that feature as part of their command functions. Although each key may possess certain limitations in accessing a vehicle, the primary key 106, the secondary key 107 and the alternate key are all types of keys saved in a cache memory system 116, allowing for an automatic entry when in range of the vehicle unit 102.

FIG. 4 depicts the initial recognition process between the primary key 106 holder and the unit 102 according to one embodiment of the present invention. In this embodiment, when the product is first used, the mobile device 101 that sets up the link becomes the primary mobile device (i.e., holding the primary key 106), and pairs itself with the unit 102. The mobile device 101 connected as the primary key 106 may require an authentication code based on vehicle's device number to validate the key's authority, and may then allow the primary key 106 holder to access the functionalities of the vehicle. From that point on, the unit 102 may only accept the mobile device 101 identification signal for connection. No other device may be set up as the primary mobile device on this unit 102 until the primary key 106 resets the primary mobile device. As the primary key 106 user, a first time Internet connection to the mobile device 101 may be required to validate both the primary key 106 used y the user and the mobile device 101. After the initial setup is completed, an Internet connection is not required. Verification may be performed through the cache memory system 116 that allows for an offline usage of the different keys. In this embodiment, no Internet connection is required after this stage because the cache memory 116 stores the last saved primary key 106 user and secondary key 107 users of the vehicle, rendering their accessibility of the vehicle possible by default. Without the need for an authentication procedure between the mobile device 101 and the cloud administrator 103, the cache memory 116, may operate automatically based on saved mobile device credentials.

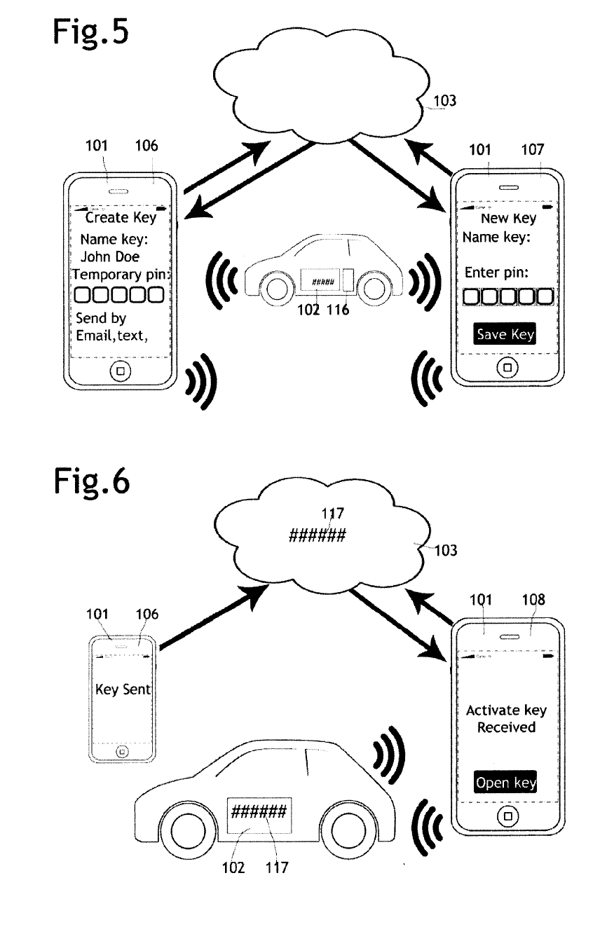

FIG. 5 depicts the initial recognition process between a secondary key 107 holder and the unit 102 according to one embodiment of the present invention. The recognition of the secondary key 107 is done by pairing a secondary user's mobile device 101.2 to the unit 102 through a transferring process that is done within the range of the unit 102. In this embodiment, to validate the secondary key 107, both the primary key 106 and secondary key 107 must be in range of the unit 102, along with Internet connectivity. Secondary key 107 users may operate the keyless system by first downloading the proprietary application. The owner of the primary key 106 may then submit a temporary access code to the intended user for the accessibility of his vehicle. When the first-time authentication process is complete, secondary key 107 users may be stored in the cache memory 116, granting them access to the vehicle by default without the need for the cloud administrator 103 to validate the signals. The cache memory 116 may temporarily replace the cloud administrator 103 when accessing a vehicle in an area that does not allow for Internet communication.

FIG. 6 depicts the initial recognition process between the shared access key 108 and the unit 102 according to one embodiment of the present invention. The shared transaction may be completed anywhere, as long as both the primary key 106 and shared key 108 users have Internet access. This gives the ability to provide an access link to this code for shared users via text, email, or other forms of communication for download of the secondary key to the mobile device 101.3. A pseudo random generator 117 in the administrator cloud 103 provides a code to the unit 102 for authenticating the shared key 108 therewith the server (e.g., for the duration that the shared key 108 is activated). The code is also shared with the mobile device 101.3. The unit 102 authenticates the secondary key 108 by matching the code.

FIG. 7 portrays a graphical user interface of on the mobile device 101 from the perspective of a primary key 106 holder. The interface is composed of a number of features. In one embodiment, the mobile device 101 may have the option to manually lock/unlock doors 112. Another aspect includes an alternate access mode 113, and access to logs 115. These are all interactive functions that may be both manually and/or automatically activated through the mobile device 101 within a specified range of the unit 102.

FIG. 8 demonstrates the manually lock/unlock 112 process according to one embodiment of the invention, as well as the car starter when a user holding the mobile device 101 approaches, and enters the vehicle. When the user approaches the unit 102 and reaches a specified range therefrom, the recognition of the mobile device's 101 ID will enable the car to unlock accordingly. Signal recognition begins at 50 meters for wireless connection, and the authentication of the mobile device 101 is granted when the mobile device 101 is at a closer proximity to unit 102. Simultaneously, the car will also close a relay switch that is placed in the vehicles ignition wire. This will act as an immobilizer device for the vehicle. If the corresponding mobile device 101 for the vehicle is not present, the ignition wire will not conduct electricity, and the vehicle will not be allowed start. The vehicle will start if the unit 102 indicates presence of a valid mobile device 101 holding an appropriate key. Once a destination is reached and the car is turned off, the distance may once again be monitored. When the user is at a certain range from the unit 102, it may lock and open the relay switch preventing the car from operating. The system may be developed with a specified range of operability between the handheld transmitter and the installed vehicle starter interface.

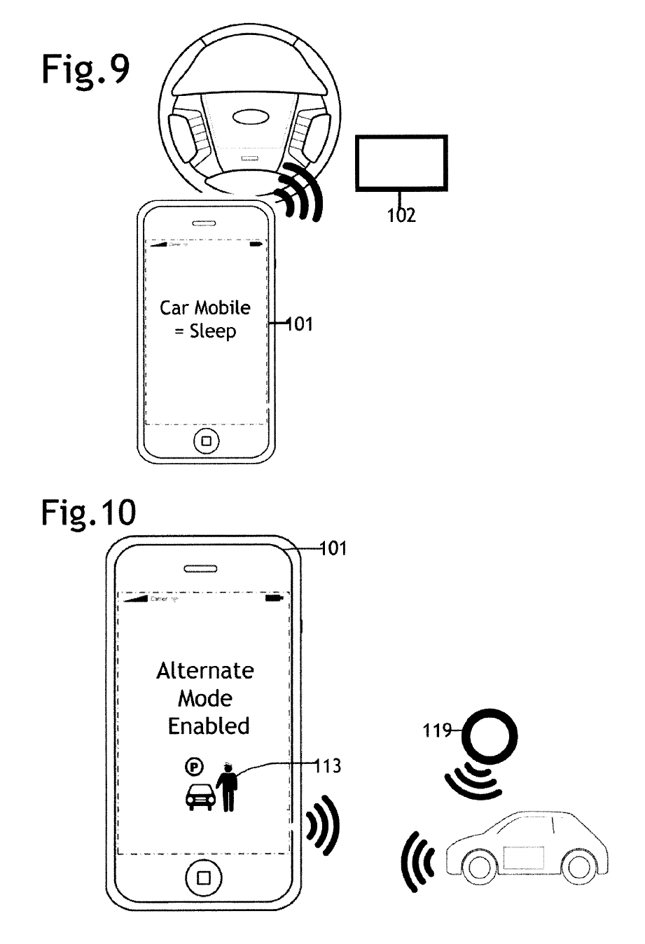

FIG. 9 illustrates the communication between the mobile device 101 and the unit 102 as the vehicle is being mobilized according to one embodiment of the invention. When the car is in motion, the unit 102 may cease searching and scanning for the mobile device 101, as well as the mobile device 101 may also cease its broadcasting signal seeking to authenticate. Once connected to the vehicle's device, the unit 102 sends a signal to the mobile device 101, instructing both the unit 102 and the mobile device 101 to sleep since the car is mobile.

FIG. 10 depicts the alternate access mode 113 according to one embodiment of the invention. Without having to share keys with other users or even allowing them restricted accessibility, an alternate key 119 can also be used to enable the lock/unlock/engine start functions of a vehicle. This feature is commonly used for a variety of services: mechanic garages, car wash, and even valet parking. When the alternate access mode 113 setting is enabled, the vehicle may activate the automatic keyless short-range alternate fey 119, allowing the momentary user to operate the vehicle. When the alternate access mode is enabled, the unit 102 may activate its short-range signal. Also, when driving in the alternate mode, the user may be constrained by a speed restriction. In FIG. 10., the alternate key 119 may be an Original Equipment Manufacturer (OEM) key that can be detected (e.g., based on a multitude of metrics) to determine if it disarmed the vehicle in a certain method, (e.g., to guarantee entry).

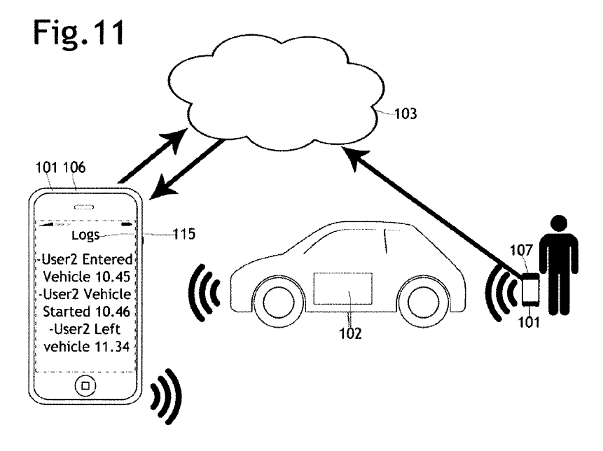

FIG. 11 depicts the access to logs 115 procedure as being the feature that informs the primary key 106 user when a secondary key 107 user or shared key 108 user has accessed the vehicle through the unit 102 according to certain embodiments of the present invention. Logs may notify the primary key 106 user the date and time in which other users have locked, unlocked or even started the vehicle, as well as confirms the identification name of the user.

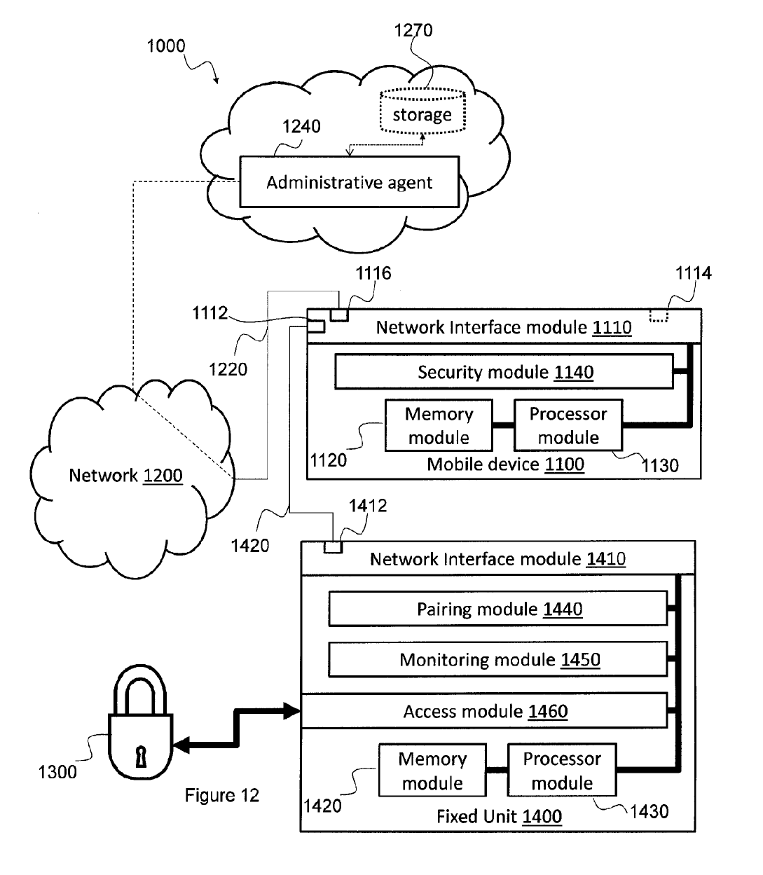

FIG. 12 is a modular representation of an exemplary system 1000 in accordance with one embodiment of the present invention. The system 1000 comprises a mobile device 1100, a network 1200, a locked (or lockable) area 1300 (e.g., a vehicle) and a fixed unit 1400. In the depicted example of FIG. 12, the mobile device 1100 comprises a memory module 1120, a processor module 1130 and a security module 1140. The mobile node 1100 can communicate with other nodes through a network interface module (NI) 1110. The NI module 1110 comprises at least one physical port 1116 to be connected (or connectable) to the network 1200. The physical port 1116 is for communicating with remote nodes (typically a long range radio transceiver or a Wide Area Network (WAN) interface e.g., 3G, WiMax, 4G/LTE cellular network, etc.). Skilled persons will readily understand that the connection 1220 represents a logical connection and that different network nodes (e.g., routers, switches, etc.) are present thereon. The same comment applies to other depicted links.

The NI module 1110 comprises at least one local interface 1112 (e.g., short range radio transceiver) connectable to the fixed unit 1400. In order for the local connection 1420 to occur there between, the fixed unit 1400 have to at least temporarily be located within the maximum range thereof. The local interface 1112 may then exchange instructions with the fixed unit 1400.

The fixed unit 1400 comprises a memory module 1420, a processor module 1430, pairing module 1140, a monitoring module 1450 and an access module 1460. The fixed unit 1400 can communicate with other nodes through a network interface module (NI) 1410. The NI module 1110 comprises at least one local interface 1412 (e.g., short range radio transceiver) connectable to the mobile device 1100. The local interface 1112 may then exchange instructions with the mobile device 1100. In addition, the local interface 1112 may further allow the fixed unit 1400 to communicate with an administrative agent 1240 (e.g., located in the “the cloud”) via the mobile device 1100 (e.g., via the link 1220).

The network 1200 is exemplified as two separate interconnected sub-networks, but could also be a single network 1200 or, a plurality of sub-networks. The network 1200 comprises the administrative agent 1240, which may further be in communication with a storage module 1270.

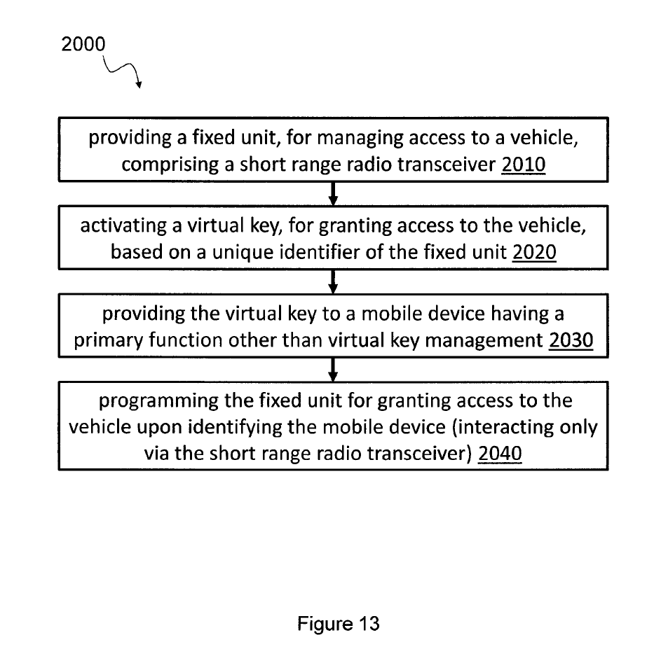

Reference is now made concurrently to FIG. 12 and FIG. 13, which shows an exemplary method 2000, which may be implemented using the system 1000, for managing access to a vehicle. The method 2000 comprises providing (2010) the fixed unit 1400, in the vehicle, for managing access to the vehicle, the fixed unit 1400 comprising a short range radio transceiver 1412 and activating (2020) a virtual key, for granting access to the vehicle, based on a unique identifier of the fixed unit 1400. The virtual key is then provided (2030), over a network (e.g., 1200), for local storage into the mobile device 1100. The mobile device 1100 has a primary function other than virtual key management. More specifically, the expectation of the mobile device 110 is to be a smart device having the primary function of a cell phone and/or intelligent music device. The method 2000 also comprises programming (2040) the fixed unit 1400 for granting access to the vehicle upon identifying the mobile device 1100. The fixed unit 1400 interacts only via the short range radio transceivers 1112, 1412 while granting access.

Optionally, providing the virtual key may further comprise sending the virtual key to the mobile device 1100 for reception via a long range radio transceiver of the network interface module 1110 of the mobile device 1100 (e.g., from the administrative agent 1240).

The virtual key may also have a preset expiry condition and the method 2000 may then further comprise disabling the virtual key in the mobile device 1100, without confirming via the long range radio transceiver, when the condition is met. The disabled key prevents the mobile device 1100 from requesting access to the fixed unit 1400 over the short range radio transceiver 1112, 1412. The disabled key may also trigger a communication from the mobile device 110 to the fixed unit 1400 over the short range radio transceiver 1112, 1412 to act upon the functions of the vehicle (as exemplified in subsequent examples).

The virtual key may also grant access to a set of functions of the vehicle and the method 2000 may then further comprise programming the fixed unit 1400 for granting access to the set of functions of the vehicle upon identifying the mobile device 1100 (e.g., from the administrative agent 1240, through the mobile device 110). The set of functions may comprise starting the engine or accessing configuration between the fixed unit 1400 and the vehicle. The method 2000 may also optionally further comprise activating a second virtual key (e.g., at the administrative agent 1240, from the mobile device 1100), for granting access to the vehicle and to a subset of the set of functions of the vehicle, based on the unique identifier and programming the fixed unit 1400 for granting access to the vehicle and to a subset of the set of functions (e.g., only starting the engine) of the vehicle, e.g., upon receiving credentials related to the second virtual key from a second mobile device (not shown). In this example, the fixed unit 1400 interacts only via a short range radio transceiver while granting access and the second mobile device has a primary function other than virtual key management.

The method 2000 may also comprise, at the fixed unit 1400, measuring a speed at which the mobile device is approaching the vehicle to determine when to grant access to the vehicle. Preferences may be set in the mobile device 110 for that purpose and communicated to the fixed unit 1400 during one close-proximity connection (the same can be said to other preferences set by a user in the mobile device 1100 that need to be transmitted to the fixed unit 1400). For instance, the fixed unit 1400 may initiate a procedure once it establishes a connection with the mobile device 1100. This procedure may take a buffering average of Receive Signal Strength Indicators (RSSI) signals, and calculate the output several times a second. The derivative of this function may also be calculated as well as the changing integral from one second to another. The derivative may be used to predict how fast the mobile device 1100 is approaching the vehicle and the change in integral may be used to determine the relative strength of the signal. The combination of these results may be used to determine if the mobile device 1100 is approaching the vehicle and in range. Skilled persons will readily recognize that other means of calculation speed may be used without affecting the present invention.

As another option, the method 2000 may further comprise sending (e.g., from the administrative agent 1240), to the mobile device, a content file for transmission to the fixed unit 1400 over the short range radio transceiver when the mobile device 1100 is connected therewith. An audio and/or video content from the content file may further be conditionally provided by the fixed unit 1400 within the vehicle. The content may be provided based on one or more of vehicle engine being on or off, vehicle engine RPMs, vehicle doors being locked or not, vehicle radio being on or off, noise level within the vehicle. The content file may be personalized (e.g., at the administrative agent 1240) based on a known user of the mobile device 1100 and/or location of the mobile device 1100 and/or trigger at a point along an expected route of the known user. Use of the content file by the fixed unit 1400 may further trigger a dialog on the mobile device 1100 (e.g., the fixed unit 1400 indicating to the mobile device 1100 that the content file has been used over the short range radio transceiver 1112, 1412 or the mobile device 1100 listening and detecting an audio cue within the vehicle indicating that the audio/video content of the content file has been delivered). Having played the audio/video and/or interacting with the dialog may further be conditional to one or more functions associated to the virtual key (e.g., allowing starting the engine only if you assert that you did not drink alcohol in the last hour). A report could be sent from the mobile device 110 towards the administrative agent 1240.

In some embodiments (e.g., fleet management) a plurality of virtual keys may be provided and a plurality of fixed units may be deployed over a plurality of vehicles. The fixed unit 1400 may be provided for installation in the vehicle or may be installed as an option or as a standard feature by the vehicle manufacturer or car dealer.

Optionally, parameters of the virtual key may indicate at least one condition of the virtual key to the fixed unit 1400 and the method 2000 may then further comprise providing a warning within the vehicle, from the fixed unit 1400, in relation to the condition (e.g., maximum time of use or distance travelled allowed for the vehicle in a day, the warning being provided at different threshold (25%, 50%, 75%). After providing the warning, the method 2000 may further comprise safely disabling the virtual key, from the fixed unit 1400, when the condition is met (e.g., shutting down the engine or limiting speed (e.g., to 10 km/h) the next time the vehicle completely stops or completely stops for a predetermined period of time (e.g., 30 seconds, 3 minutes), etc.). The fixed unit 1400 could also take various logs (distance, speed, location) uploaded to the mobile device 1100 at certain threshold (e.g., upon connection, upon reaching a log size, upon request from the mobile device 1100, etc.). A report could be sent from the mobile device 110 towards the administrative agent 1240.

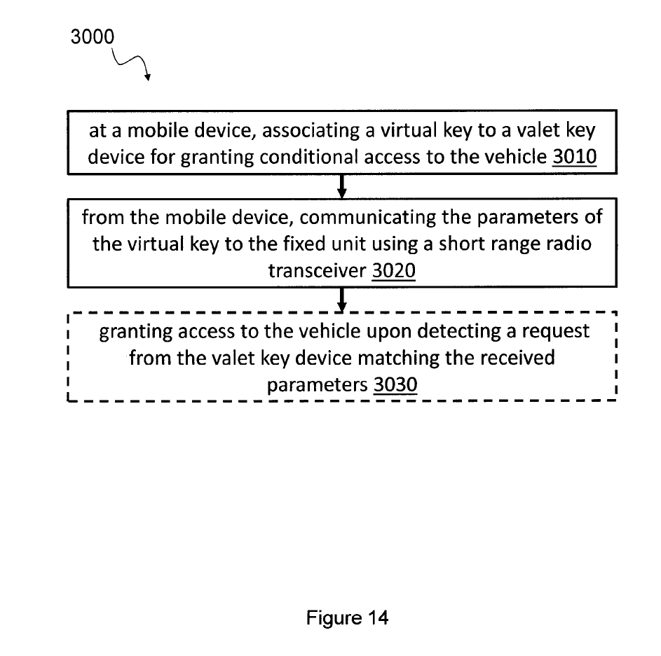

Reference is now made concurrently to FIG. 12 and FIG. 14, which shows an exemplary method 3000, which may be implemented using the system 1000, for activating temporary access to a vehicle comprising the fixed unit 1400 for managing access to the vehicle. The method 3000 comprises, from the mobile device 1100 (e.g., from the security module 1140), associating (3010) a virtual key to a valet key device for granting conditional access to the vehicle. The mobile device 1100 has a primary function other than virtual key management. From the mobile device 1100 (e.g., from the security module 1140), communicating (3020) the parameters of the virtual key to the fixed unit using a short range radio transceiver 1112, 1412. The method 3000 may further comprise, from the fixed unit 1400, granting access (3040) to the vehicle upon detecting a request from, or detecting in proximity, the valet key device matching the received parameters.

The valet key device may be a conventional remote key of the vehicle or the valet key device may be equipped with a short range radio transceiver. In this second exemplary case, the method 3000 may further comprise, from the mobile device 1110, communicating the parameters of the virtual key to the valet key device using the short range radio transceiver 1112.

The parameters of the virtual key may further indicate at least one function of the vehicle accessible to the valet key device (as previously exemplified). The parameters of the virtual key may also further indicate at least one time or distance condition and the method 3000 may then further comprise providing a warning within the vehicle (as previously exemplified), from the fixed unit 1400, e.g., based on the time or distance condition. The fixed unit 1400 could also take various logs (as previously exemplified).

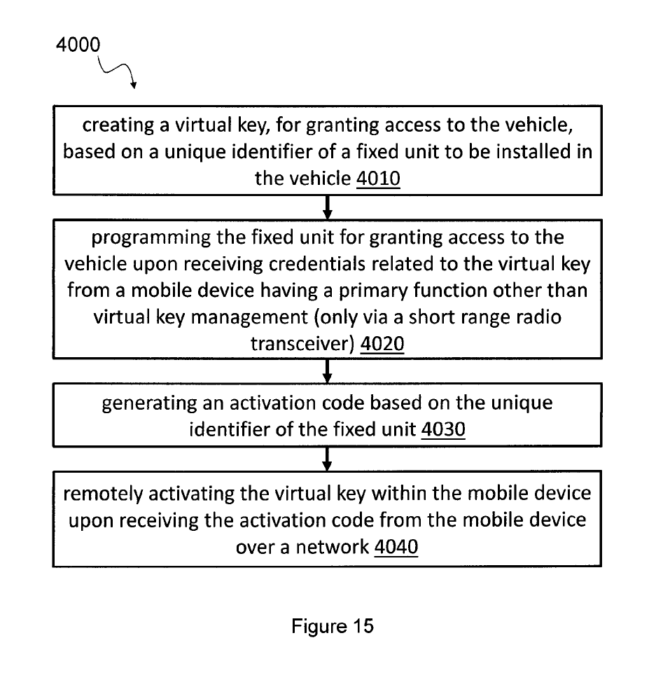

Reference is now made concurrently to FIG. 12 and FIG. 15, which shows an exemplary a method 4000, which may be implemented using the system 1000, for managing access to a vehicle comprising creating (4010) a virtual key (e.g., at the administrative agent 1240, via the mobile device 1100), for granting access to the vehicle, based on a unique identifier of the fixed unit 1400 to be installed in the vehicle and programming (4020) the fixed unit 1400 for granting access to the vehicle upon receiving credentials related to the virtual key from the mobile device 1100. The fixed unit 1400 interacts only via a short range radio transceiver 1412 while granting access and the mobile device 1100, which has a primary function other than virtual key management (as previously exemplified). The method 4000 also comprises generating (4030) an activation code (e.g., at the administrative agent 1240) based on the unique identifier of the fixed unit 1400 and remotely activating (4040) the virtual key within the mobile device 1100 upon receiving the activation code (e.g., at the administrative agent 1240) from the mobile device 1100 over a network (e.g., 1300).

The virtual key may optionally grant access to a set of functions of the vehicle (as previously exemplified) and the method 4000 may further comprise programming the fixed unit 1400 for granting access to the set of functions of the vehicle (as previously exemplified) upon receiving credentials related to the virtual key from the mobile device 1100. The virtual key may also grant access to a set of functions of the vehicle (as previously exemplified) and the method 4000 may then further comprise creating a second virtual key (e.g., at the administrative agent 1240, via the mobile device 1100), for granting access to the vehicle and to a subset of the set of functions of the vehicle (as previously exemplified), based on the unique identifier and programming the fixed unit for 1400 granting access to the vehicle and to a subset of the set of functions of the vehicle upon receiving credentials related to the second virtual key from a second mobile device. In this example, the fixed unit 1400 interacts only via the short range radio transceiver 1412 while granting access and the second mobile device, which has a primary function other than virtual key management (as previously exemplified). The method 4000 may also comprise generating a second activation code based on the unique identifier of the fixed unit 1400 and remotely activating the second virtual key within the mobile device 1100 upon receiving the activation code from the second mobile device over the network (e.g., 1300)

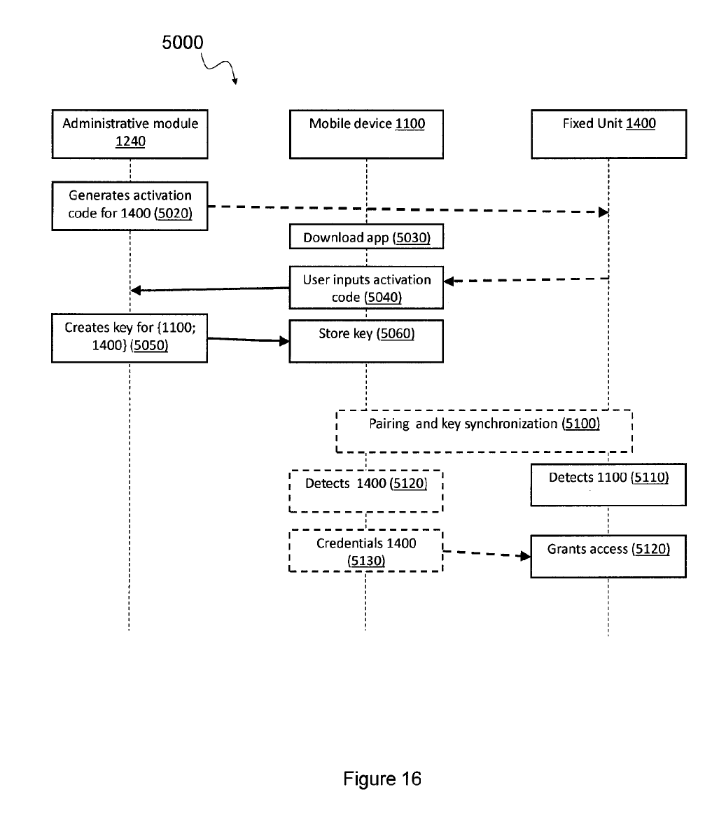

Reference is now made concurrently to FIG. 12 and FIG. 16, which shows a flow and nodal operation chart of an exemplary embodiment 5000 in accordance with the teachings of the present invention.

In the depicted example, the administrative module 1240 generates activation code for 1400 (5020), which is provided to the fixed unit 1400 (e.g., local input at the time of manufacturing the fixed unit). The mobile device 1100 downloads a software application (5030), e.g., for managing virtual key(s) and interacting (e.g., securely) with the administrative module 1240. The mobile device 1100 user inputs the activation code (5040) towards the administrative module 1240. The activation code may be read or provided by a physical support provided to the user at the time the fixed unit 1400 was acquired. The activation code may also be provided by the fixed unit 1400 if the pairing (or other form of local communication) is established before activation. The administrative module 1240 then creates virtual key(s) for {1100; 1400} (5050) or activate existing ones. The virtual key(s) is provided to the mobile device 1100 (and other devices if applicable) for locally storing the virtual key (5060). Optionally, the fixed unit 1400 and the mobile device 1100 may pair and synchronize virtual key(s) (5100). For instance, the pairing may occur over the Bluetooth™ protocol. In one embodiment, only the fixed unit 1400 detects proximity presence of the mobile device 1100 (5110). The mobile device 1100 may also detect proximity presence of the fixed unit 1400 (5120). Credentials for the fixed unit 1400 (5130) may be sent from the mobile device 110 to the fixed unit 1400 before access is granted (5120). The credentials could also be actively requested (whether 5120 occurs or not) by the fixed unit 1400 (not shown) before access is granted (5120).

The different processor modules may represent a single processor with one or more processor cores or an array of processors, each comprising one or more processor cores. The memory modules may comprise various types of memory (different standardized or kinds of Random Access Memory (RAM) modules, memory cards, Read-Only Memory (ROM) modules, programmable ROM, etc.). The storage devices module may represent one or more logical or physical as well as local or remote hard disk drive (HDD) (or an array thereof). The storage devices module may further represent a local or remote database made accessible through a network node by a standardized or proprietary interface. The network interface modules represent at least one physical interface that can be used to communicate with other network nodes. The network interface modules may be made visible to the other modules of their respective nodes through one or more logical interfaces. The actual stacks of protocols used by the physical network interface(s) and/or logical network interface(s) of the network interface modules do not affect the teachings of the present invention. The variants of processor module, memory module, network interface module and storage devices module usable in the context of the present invention will be readily apparent to persons skilled in the art. Likewise, even though explicit mentions of the memory modules and/or the processor modules are not made throughout the description of the present examples, persons skilled in the art will readily recognize that such modules are used in conjunction with other modules of their respective node to perform routine as well as innovative steps related to the present invention.

Some exemplary advantages may be provided by some embodiments in accordance with the teachings of the present invention. For instance, some embodiments may provide a clear sense of convenience. Some embodiments may provide an easy method of sharing, limiting accessibility functions, and being aware of who uses one's vehicle, and may be performed through a mobile device that relate to convenience. Some embodiments may provide financial checks, where the communication process involves utilizing the existing internet connection of the mobile device, providing a functionality without requiring a monthly membership for the vehicle's connection system. Some embodiments may provide authentication being always done from the cloud administration, where it monitors all the devices that have permission to access a primary user's vehicle, as well as controls the individual user's restrictions for management purposes. Some embodiments may provide no user interaction with the mobile device being required to access the functions of the vehicle. The vehicle unlocks when in range, disengages the immobilizer when the ignition process is activated, and re-engages the alarm when moving away from the vehicle. Some embodiments may provide a seamless integration of the vehicle and mobile device without limitations. Some embodiments may provide Shared Access Key which can grant access of your vehicle to another user located in another geographical area. For instance, a shared key may be sent through means of Internet communication.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for managing access to a vehicle comprising:
providing a fixed unit, in the vehicle, for managing access to the vehicle, the fixed unit comprising a short range radio transceiver;
activating a virtual key, for granting access to the vehicle, based on a unique identifier of the fixed unit;
providing the virtual key, over a network, for local storage into a mobile device, the mobile device having a primary function other than virtual key management; and
programming the fixed unit for granting access to the vehicle upon identifying the mobile device, wherein the fixed unit interacts only via the short range radio transceiver while granting access.

2. The method of claim 1, wherein providing the virtual key further comprises sending the virtual key to the mobile device for reception via a long range radio transceiver of a network interface module of the mobile device.

3. The method of claim 1 or claim 2, wherein the virtual key has a preset expiry condition, the method further comprising disabling the virtual key in the mobile device, without confirming via the long range radio transceiver, when the condition is met, the disabled key preventing the mobile device from requesting access to the fixed unit over the short range radio transceiver.

4. The method of any one of claims 1 to 3, wherein the virtual key grants access to a set of functions of the vehicle, the method further comprising programming the fixed unit for granting access to the set of functions of the vehicle upon identifying the mobile device.

5. The method of claim 4, further comprising:
activating a second virtual key, for granting access to the vehicle and to a subset of the set of functions of the vehicle, based on the unique identifier; and
programming the fixed unit for granting access to the vehicle and to a subset of the set of functions of the vehicle upon receiving credentials related to the second virtual key from a second mobile device, wherein the fixed unit interacts only via a short range radio transceiver while granting access and wherein the second mobile device has a primary function other than virtual key management.

6. The method of any one of claims 1 to 5, further comprising, at the fixed unit, measuring a speed at which the mobile device is approaching the vehicle to determine when to grant access to the vehicle.

7. The method of any one of claims 1 to 6, further comprising sending, to the mobile device, a content file for transmission to the fixed unit over the short range radio transceiver when the mobile device is connected therewith, wherein an audio and/or video content from the content file is conditionally provided by the fixed unit within the vehicle.

8. The method of claim 7, wherein the content is provided based on one or more of vehicle engine being on or off, vehicle engine RPMs, vehicle doors being locked or not, vehicle radio being on or off, noise level within the vehicle.

9. The method of any one of claims 1 to 8, wherein a plurality of virtual keys are provided and a plurality of fixed units are deployed over a plurality of vehicles.

10. The method of any one of claims 1 to 9, wherein the fixed unit is provided for installation in the vehicle.

11. The method of any one of claims 1 to 10, wherein parameters of the virtual key indicate at least one condition of the virtual key to the fixed unit, the method further comprising providing a warning within the vehicle from the fixed unit, in relation to the condition.

12. The method of claim 11, further comprising, after providing the warning, safely disabling the virtual key, from the fixed unit, when the condition is met.

13. A method for activating temporary access to a vehicle comprising a fixed unit for managing access to the vehicle, the method comprising:
from a mobile device, associating a virtual key to a valet key device for granting conditional access to the vehicle, the mobile device having a primary function other than virtual key management; and
from the mobile device, communicating the parameters of the virtual key to the fixed unit using a short range radio transceiver.

14. The method of claim 13, further comprising, from the fixed unit, granting access to the vehicle upon detecting a request from the valet key device matching the received parameters.

15. The method of claim 13 or claim 14, wherein the valet key device is a conventional remote key of the vehicle.

16. The method of claim 13 or claim 14, wherein the valet key device is equipped with a short range radio transceiver, the method further comprising, from the mobile device, communicating the parameters of the virtual key to the valet key device using the short range radio transceiver.

17. The method of any one of claims 13 to 16, wherein the parameters of the virtual key indicate at least one function of the vehicle accessible to the valet key device.

18. The method of any one of claims 13 to 17, wherein the parameters of the virtual key indicate at least one time or distance condition, the method further comprising providing a warning within the vehicle, from the fixed unit, based on the time or distance condition.

19. A method for managing access to a vehicle comprising:
creating a virtual key, for granting access to the vehicle, based on a unique identifier of a fixed unit to be installed in the vehicle;
programming the fixed unit for granting access to the vehicle upon receiving credentials related to the virtual key from a mobile device, wherein the fixed unit interacts only via a short range radio transceiver while granting access and wherein the mobile device has a primary function other than virtual key management;
generating an activation code based on the unique identifier of the fixed unit; and
remotely activating the virtual key within the mobile device upon receiving the activation code from the mobile device over a network.

20. The method of claim 19, wherein the virtual key grants access to a set of functions of the vehicle, the method further comprising:
programming the fixed unit for granting access to the set of functions of the vehicle upon receiving credentials related to the virtual key from the mobile device.

21. The method of claim 20, wherein the virtual key grants access to a set of functions of the vehicle, the method further comprising:
creating a second virtual key, for granting access to the vehicle and to a subset of the set of functions of the vehicle, based on the unique identifier;
programming the fixed unit for granting access to the vehicle and to a subset of the set of functions of the vehicle upon receiving credentials related to the second virtual key from a second mobile device, wherein the fixed unit interacts only via a short range radio transceiver while granting access and wherein the second mobile device has a primary function other than virtual key management;
generating a second activation code based on the unique identifier of the fixed unit; and
remotely activating the second virtual key within the mobile device upon receiving the activation code from the second mobile device over the network.

22. A system for managing access to a remote vehicle comprising:
a fixed unit, in the vehicle, for managing access to the vehicle, the fixed unit comprising a short range radio transceiver;
an administrative agent for:
activating a virtual key based on a unique identifier of the fixed unit, the virtual key granting access to the vehicle;
providing the virtual key, over a network, for local storage into a mobile device, the mobile device having a primary function other than virtual key management; and
programming the fixed unit for granting access to the vehicle upon identifying the mobile device, wherein the fixed unit interacts only via the short range radio transceiver while granting access.

23. The system of claim 22, wherein the administrative agent further sends the virtual key to the mobile device for reception via a long range radio transceiver of a network interface module of the mobile device.

24. The system of claim 22 or claim 23, wherein the virtual key has a preset expiry condition, the mobile device being for disabling the virtual key without confirming via the long range radio transceiver, when the condition is met, the disabled key preventing the mobile device from requesting access to the fixed unit over the short range radio transceiver.

25. The system of any one of claims 22 to 24, wherein the virtual key grants access to a set of functions of the vehicle, the administrative agent being further for programming the fixed unit for granting access to the set of functions of the vehicle upon identifying the mobile device.

26. The system of claim 25, wherein the administrative agent is further for:
activating a second virtual key, for granting access to the vehicle and to a subset of the set of functions of the vehicle, based on the unique identifier; and
programming the fixed unit for granting access to the vehicle and to a subset of the set of functions of the vehicle upon receiving credentials related to the second virtual key from a second mobile device, wherein the fixed unit interacts only via a short range radio transceiver while granting access and wherein the second mobile device has a primary function other than virtual key management.

27. The system of any one of claims 22 to 26, further comprising, at the fixed unit, measuring a speed at which the mobile device is approaching the vehicle to determine when to grant access to the vehicle.

28. The system of any one of claims 22 to 27, wherein the administrative agent is further for sending, to the mobile device, a content file for transmission to the fixed unit over the short range radio transceiver when the mobile device is connected therewith, wherein an audio and/or video content from the content file is conditionally provided by the fixed unit within the vehicle.

29. The system of claim 28, wherein the content is provided based on one or more of vehicle engine being on or off, vehicle engine RPMs, vehicle doors being locked or not, vehicle radio being on or off, noise level within the vehicle.

30. The system of any one of claims 22 to 29 further comprising a plurality of virtual keys and a plurality of fixed units deployed over a plurality of vehicles.

31. The system of any one of claims 22 to 30, wherein parameters of the virtual key indicate at least one condition of the virtual key to the fixed unit, the fixed unit further providing a warning within the vehicle, from the fixed unit, in relation to the condition.

32. The system of claim 31, wherein the fixed unit, after providing the warning, is for safely disabling the virtual key when the condition is met.

33. A mobile device for activating temporary access to a vehicle comprising a fixed unit for managing access to the vehicle, the mobile node comprising:
a security module for:
associating a virtual key to a valet key device for granting conditional access to the vehicle, the mobile device having a primary function other than virtual key management; and
communicating the parameters of the virtual key to the fixed unit using a short range radio transceiver.

34. The mobile device of claim 33, wherein the parameters of the virtual key require the fixed unit to grant access to the vehicle upon detecting a request from the valet key device matching the received parameters.

35. The mobile device of claim 34, wherein the security module further communicates the parameters of the virtual key to the valet key device valet key device, equipped with a short range radio transceiver, using the short range radio transceiver.

36. The mobile device of any one of claims 33 to 35, wherein the parameters of the virtual key indicate at least one function of the vehicle accessible to the valet key device.

37. The mobile device of any one of claims 33 to 36, wherein the parameters of the virtual key indicate at least one time or distance condition for providing a warning within the vehicle based on the time or distance condition.

38. An administrative agent for managing access to a vehicle comprising a network interface module; and
a security module for:
creating a virtual key, for granting access to the vehicle, based on a unique identifier of a fixed unit to be installed in the vehicle;
programming the fixed unit for granting access to the vehicle upon receiving credentials related to the virtual key from a mobile device, wherein the fixed unit interacts only via a short range radio transceiver while granting access and wherein the mobile device has a primary function other than virtual key management;
generating an activation code based on the unique identifier of the fixed unit; and
remotely activating the virtual key, via the network interface module, within the mobile device upon receiving the activation code from the mobile device over a network.

39. The administrative agent of claim 38, wherein the virtual key grants access to a set of functions of the vehicle, the security module being further for:
programming the fixed unit for granting access to the set of functions of the vehicle upon receiving credentials related to the virtual key from the mobile device.

40. The administrative agent of claim 39, wherein the virtual key grants access to a set of functions of the vehicle, the security module being further for:
creating a second virtual key, for granting access to the vehicle and to a subset of the set of functions of the vehicle, based on the unique identifier;
programming the fixed unit for granting access to the vehicle and to a subset of the set of functions of the vehicle upon receiving credentials related to the second virtual key from a second mobile device, wherein the fixed unit interacts only via a short range radio transceiver while granting access and wherein the second mobile device has a primary function other than virtual key management;
generating a second activation code based on the unique identifier of the fixed unit; and
remotely activating via the network interface module, the second virtual key within the mobile device upon receiving the activation code from the second mobile device over the network.
